(19) United States
(12) Patent Application Publication
(10) Pub. No.: US 2020/0014965 A1
(43) Pub. Date: Jan. 9, 2020

(54) SYSTEMS AND METHODS FOR STREAMING LOCAL CONTENT

(71) Applicant: Streaming Television Inc., Fort Wayne, IN (US)

(72) Inventor: Simon Bray, JR., Fort Wayne, IN (US)

(21) Appl. No.: 16/457,810

(22) Filed: Jun. 28, 2019

Related U.S. Application Data
(60) Provisional application No. 62/694,128, filed on Jul. 5, 2018.

(51) Int. Cl. H04N 21/258; H04N 21/45; H04N 21/2665

(52) U.S. Cl. CPC H04N 21/25841; H04N 21/2665; H04N 21/4524

(57) ABSTRACT

The disclosure includes systems and methods for streaming local community intended content. The method may include streaming the local community intended content through an application on a digital media player. The method may further include displaying the local content on a television, wherein the television is communicatively coupled to the digital media player.

### CROSS REFERENCE TO RELATED APPLICATION

This application claims the benefit of U.S. Provisional Patent Application No. 62/694,128; filed Jul. 5, 2018; and entitled SYSTEMS AND METHODS FOR STREAMING LOCAL CONTENT; the entire contents of which are incorporated herein by reference.

### BACKGROUND

### Field

Various embodiments disclosed herein relate to streaming local content systems and methods.

### Description of Related Art

Traditional cable and satellite television services have, for a long time, been one of the main sources of media entertainment in homes across the country. Offerings on these services range from sports to news to soap operas to locally created content. Locally created content is typically broadcasted through public access channels so that everyone in the community may be able to view this content regardless of their cable provider offerings. However, more and more people are opting to replace cable and satellite television services with connected TV streaming devices, such as Amazon Fire TV, Roku TV, and Apple TV—devices that are not able to pick up public access channels. Public access channels in most cities are only accessible on cable networks, save for some that have enabled viewing on their websites. Public access channels have been left behind in the forward momentum of streaming television. There also exists a lack of public access channel capacity to fully service the needs of leadership communities across the country. Public access channels typically make up a small portion of the traditional cable and satellite television channels, and because they broadcast community based programming, any number of organizations simply may not have access to a time slot. Thus, there is a need to improve the management of local content, and to incorporate the programming of local content into streaming television mediums.

### SUMMARY

This disclosure describes methods for streaming local community intended content. The methods may include streaming local community intended content through an application on a digital media player. The local content may be displayed on a television communicatively coupled to the digital media player. The local content may originate within at least one of a county border and a state border of where the digital media player is located. The application may bear a name of a city where the local community intended originated. The digital media player may consist of at least one of a set top box type media player, a stick type media player, a remote computing device, and a computer. The remote computing device may include at least one of a smartphone and a tablet device.

The local community intended content may be provided by at least one of a local, state, and federal elected official representing the city that bears the name. The local community intended content may be provided by at least one of a community, educational, and faith-based leader; a local business owner; and a political institution. The local content may be created by a first party having a recurring time slot occurring at a predetermined interval. The predetermined interval may consist of at least one of a weekly interval and a daily interval.

This disclosure also describes methods for creating local content. The methods may include recording local content on an application on a remote computing device. The local content may be transmitted to a remote server that may be communicatively coupled to the remote computing device. The local content may be streamed through an application on a video encoder. The remote computing device may include at least one of a smartphone and a tablet device. The remote computing device may also include a computer.

The local content may be created by an elected official located within a voting district of where the digital media player is located. The local content may also be created by an educational institution located within a school district of where the digital media player is located. As well, the local content may be created by a religious institution located within a county border of where the digital media player is located.

This disclosure also includes methods for viewing local community intended content. The methods may include downloading an application on a digital media player. The local content may be displayed on a television communicatively coupled to the digital media player.

Prior to downloading the application, methods may also include searching, via the digital media player, a name of a city in which the digital media player is located. Prior to downloading the application, methods may also include searching, via the digital media player, a name of a city to which the local community intended content pertains. The application may consist of a name that includes the name of the city.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a flowchart for streaming local community intended content, according to some embodiments.

FIG. 2 illustrates a flowchart for creating local community intended content, according to some embodiments.

FIG. 3 illustrates a flowchart for viewing local community intended content, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### REFERENCE NUMERALS

10—Method for streaming
12—Local community intended content
14—Application
16—Digital media player
18—Television
20—Remote computing device
22—Border
24—First party
26—Remote server
28—Method for recording
30—Method for viewing

As the medium of television continues to evolve, shows, movies, and even sports have become available outside of the traditional cable and satellite paid television services. Almost everything that is available on cable and satellite subscription services has become available through one of many applications that enable at home on demand streaming. However, locally created, community intended content broadcasted on public access channels has remained relatively untouched by the emerging popularity of streaming television services. As such, this disclosure intends to provide systems and methods to thrust locally created, community intended content into the streaming television environment. Such systems may provide a platform for streaming local community intended content. Methods of operating the system may enable creators of local community intended content to stream live and prerecorded content to a larger audience. Methods of operating the system may also enable viewers to more easily stream the content in an on-demand manner that may be more convenient than traditional time slots.

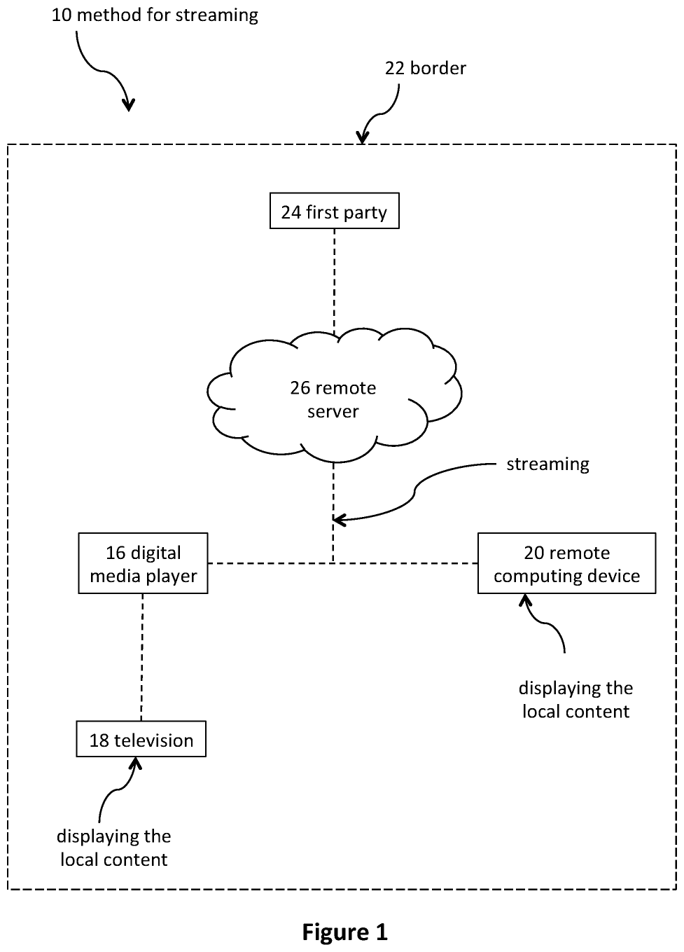

FIG. 1 illustrates a schematic of an embodiment of a method for streaming 10 a local community intended content 12 (sometimes referred to as “local content 12”). The method 10 may include streaming the local content 12 through an application 14 on a digital media player 16. The digital media player 16 may be communicatively coupled to a television 18. The method 10 may further include displaying the local content 12 on the television 18.

In some embodiments, the local content 12 may originate within a border 22 of where the digital media player 16 is located. The border 22 may include at least one of a county border, state border, city limit, town limit, neighborhood area, and the like. The border 22 may serve as a parameter to ensure that the local content 12 streaming through the application 14 is local and relevant to a viewer. Because the content offered by the system is intended to be local, the content is geared towards viewers within at least one of the aforementioned boundaries. The local content 12 is purposed to be a direct community platform, to connect, inform, and grow awareness of important issues within the user's community.

According to some embodiments, the application 14 may bear a name of a city in which the local content 12 originated. The application 14 may thusly be easily found within the digital media player 16, as the name of the application 14 may represent the local content 12 that may pertain to the user. The application may also bear the name of at least one of a state, town, county, neighborhood, country, and the like in which the local content 12 originated.

In some embodiments, the application 14 may contain subsection representing areas or boundaries within the border 22 that the application 14 may be named for. These subsections may contain local content 10 that pertains to a smaller and more focused area, such as a neighborhood area within the border 22. These subsection may also contain local content 12 that pertains to a singular group, such as a particular religious group (e.g., a church) located within the border 22.

With added reference to FIG. 1, the local content 12 may be streamed through the digital media player 16. The digital media player 16 may include at least one of a set top box type media player, a stick type media player, a remote computing device 20, a computer, an Over-the-Top connected TV streaming device, a smart television, a gaming console, and the like. The Over-the-Top connected TV streaming device may include at least one of an Amazon Fire TV, Roku TV, Apple TV, Chromecast, and the like.

The remote computing device 20 device may include at least one of a smart phone, tablet device, desktop computer, laptop computer, smart watch, any device arranged and configured to communicate via a wireless connection, and the like. The application 14 may exist on the remote computing device 20, such that streaming may be enabled by a wireless connection. This may allow streaming of the local content 12 to be available outside of the home. Traditionally, public access channels that broadcast the local content 12 are only available with cable and satellite television subscriptions. Even still, because such a subscription is needed, the local content 12 may only be available in an environment with access to cable and satellite television channels. Access to cable and satellite television channels may only be possible with physical access to a sedentary cable and satellite connection. The application 14 may allow the local content 12 to be accessed and streamed through any remote computing device 20 in virtually any location, so long as the remote computing device 20 has wireless capabilities.

In some embodiments, the local content 12 may be provided by a first party 24. The first party 24 may include at least one of a local, state, and federal elected official that may represent the area denoted by the name of the application 14. The elected official may create content geared towards a particular community or group. For example, the elected official may create content regarding an issue pertaining to a particular city that may not have interest outside of the city's limits. The elected official may thus be enabled to create a genuine relationship with that community to open a dialogue about issues of the area. Viewers of the content may be able view the content in a variety of environments, so long as a viewer has access to a digital media player containing the application 14. Access to such content outside of traditional public access channel environments, typically residences, allows viewers to keep up to date with important community issues, events, and the like regardless of the viewer's location.

In some embodiments, the first party 24 may include at least one of a community, educational, and faith-based organizational leader, a business owner, a political institution, and the like. The first party 24 may create a variety of local community intended content 10, including public service announcements, local business information, religious discussions, current events, future events, community issues, fundraisers, charity events, political discussions, information regarding at least one of a school and a school district, educational changes, educational leadership, safety issues, health and safety support, and the like.

In further reference to FIG. 1, the first party 24 may provide local content 12 to the remote server 24 for streaming through the application 14. In some embodiments, the local content 12 may include at least one of live and prerecorded content. At least one of the remote server 24 and the application 14 may store the local content 12 for future viewing, such that the local content 12 may be prerecorded. The first party 24 may have a recurring time slot. The recurring time slot may occur at a predetermined interval. The predetermined time interval may include at least one of a daily interval, weekly interval, monthly interval, and the like. The recurring time slot may consist of at least one of live local content 12 and prerecorded local content 12, wherein the local content 12 may be provided by the remote server 24.

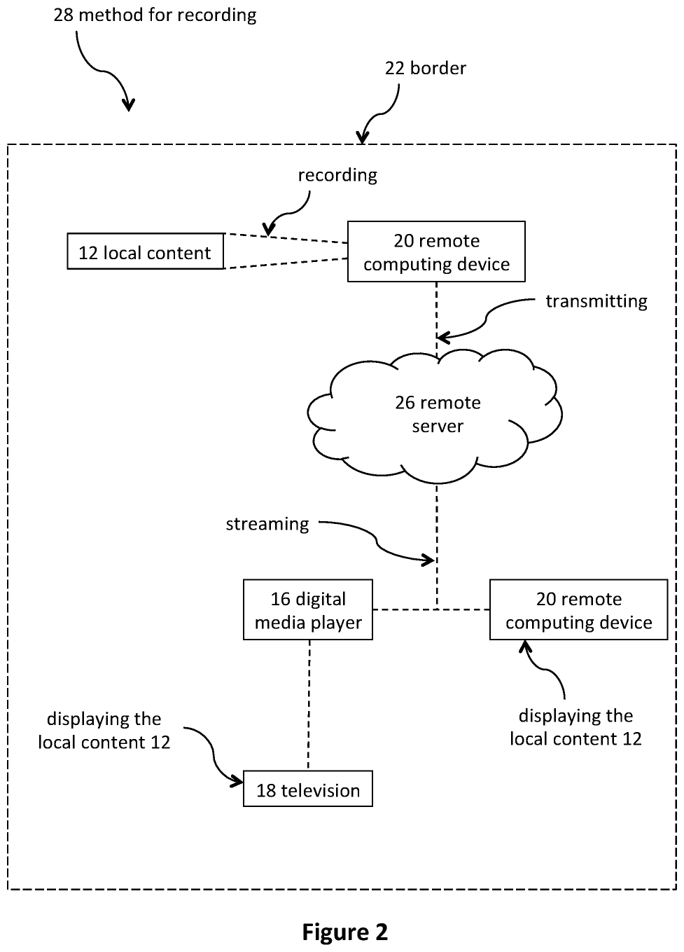

FIG. 2 illustrates a schematic of a method 28 for creating local community intended content 12. The method 28 may include recording the local content 12 on an application with recording capabilities on a remote computing device 20. The remote computing device 20 may be communicatively couple to a remote server 26. The method 28 may further include transmitting the local content 12 from the remote computing device 20 to the remote server 26.

In some embodiments, the local content 12 may be streamed through a digital media player 14. The digital media player 16 may contain an application 14. The application 14 may serve as the medium through which the local content 12 may be streamed. The application 14 may bear a name of a city in which the local content 12 originated. The application may also bear the name of at least one of a state, town, county, neighborhood, country, and the like in which the local content 12 originated.

The local content 12 may be created by the first party 24 and recorded on the remote computing device 20. The local content 12 may be available for live viewing through the digital media player 16. The local content 12 may also be stored within the remote server 26 for future viewing on the digital media player. Local content 12 stored within the remote server 26 may be available for at least one of on-demand viewing, predetermined time interval viewing, and the like. The predetermined time interval may include a recurring time slot.

For example, a neighborhood community meeting may be recorded by the remote computing device 20 and streamed live through the application 14 of the digital media player 16. Users of the application 14 may view the meeting in real time without having to physically be present at the location of the meeting. The recording of the meeting may be stored on the remote server 26 for future viewings, such as for those who are not able to attend or view the meeting, and in the case of disputes over issues discussed in the meeting.

With added reference to FIG. 2, the remote computing device 20 that the local content 12 may be recorded on may include at least one of a smart phone, tablet device, desktop computer, laptop computer, video camera with wireless capabilities, and the like. The remote computing device 20 may record the local content 12 on a platform through which the remote server 26 may access the recording. According to some embodiments, such a platform may define an application that may be communicatively coupled to both the remote computing device 20 and the remote server 26. The recording of the local content 12 may be transmitted through such application from the remote computing device 20 to the remote server 26.

In some embodiments, the remote server 26 may stream the local content 12 to the digital media player 16. The digital media player 16 may be communicatively coupled to a television 18, such that the television 18 may display the local content 12. In some embodiments, the digital media player 16 may have the ability to display the local content 12 without use of the television 18. For example, the digital media player 14 may be defined as a smart phone with the application 14. The smart phone may be able to both stream the local content 12 through the application 14 and display the local content 12.

In some embodiments, the local content 12 may be created by the first party 24. The first party 24 may include an elected official. The elected official may be located within a voting district of at least one of where the digital media player 16 is located and the region that the application 14 may be named for, as the application 12 may bear the name of an area for which the local content 12 is created. The first party 24 may also include at least one of a business institution, educational institution, religious institution, political institution, and the like. The first party 24 may create the local content 12, which may stream through the digital media player 16.

Further referring to FIG. 2, the first party 24 may be located within a border 22 of where the digital media player 14 is located. The border 22 may include at least one of a county border, state border, city limit, town limit, neighborhood area, and the like. The border 22 may serve as a parameter to ensure that the local content 12 streaming through the application 14 is local and relevant to a viewer of the local content 12. Because the content offered by the system is intended to be local, the content is geared towards users within at least one of the aforementioned boundaries.

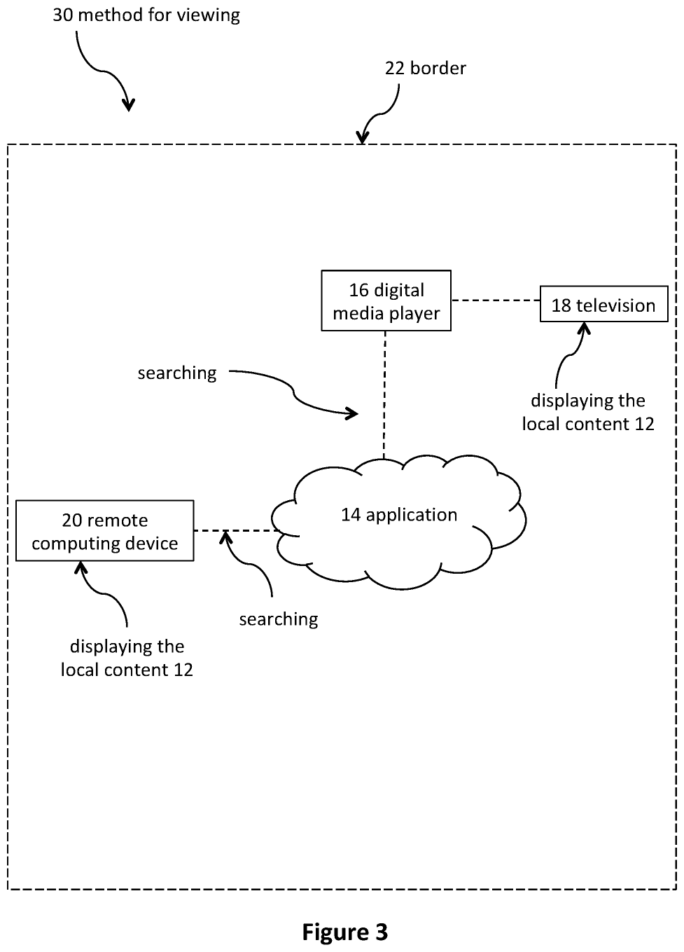

FIG. 3 illustrates a flowchart of a method for viewing 30 local community intended content 12. The method 30 may include downloading the application 14 on the digital media player 16. The digital media player 16 may be communicatively coupled to the television 18. The method 30 may further include displaying the local content 12 on the television 18.

In some embodiments, the method 30 may further include searching a name of a city via the digital media player 16 prior to downloading the application 14. The name of the city may be a city in which the digital media player 16 is located. The name of the city may be searched in order to find the application 14 within the digital media player 16. The method 30 may also include searching at least one of a name of a town, county, neighborhood, state, country, border 22, and the like in which the digital media player 16 may be located. Once the application 14 is located within the digital media player 16, the application 14 may be downloaded on the digital media player 16.

For example, the digital media player 16 may be an Apple TV, wherein the Apple TV may be located in Chicago. A user may search the Apple App Store for the word “Chicago” in order to locate the application 14. The user may then download the application 14 to the Apple TV and be enabled to stream the local content 12 through the application 14.

With added reference to FIG. 3, the method 30 may further include searching a name of a city via the digital media player 16 prior to downloading the application 14. The name of the city may be a city to which the local content 12 pertains. The name of the city may not necessarily be the city in which the digital media player 16 is located, such that the digital media player 16 may be located outside of the border 22 to which the local content 12 may pertain. A user may have access to the local content 12 of a variety of cities by searching the name of the city of which the user may interested in viewing the local content 12.

For example, the digital media player 16 may be an Apple TV located in Chicago, wherein the user wants to view local content 12 pertaining to Detroit. The user may search the App Store for the word “Detroit” in order to download the application 14 containing local content 12 regarding Detroit. This function of the system for viewing local community intended content 10 may be employed under a variety of circumstances and serve a variety of purposes. For example, when a user is on vacation, this function may allow the user to keep updated with local affairs of the city in which the user lives. The user may be able to view the local content 10 which the user is not able to physically attend, such as a PTA meeting, neighborhood meeting, local politician announcements, local forums, and the like.

In some embodiments, the application 14 may consist of a name that may include a name of a city to which the local content 12 pertains. The application 14 may at least one of be named for the city for which the local content 12 is created, include the name of the city for which the local content 12 is created, and the like. Because the application 14 may be purposed to stream local content 12, in some embodiments, the name of the application 14 may also include at least one of “Streaming”, “Streaming Television”, “Streaming Television Channel”, and the like. For example, a user in Chicago may search the word “Chicago” on a digital media player 16. The name of the application 14 may include the word “Chicago” such that the application 14 may be named at least one of “Chicago”, “Chicago Channel”, “Chicago Streaming”, “Chicago Streaming Television”, “Chicago Streaming Television Channel”, “Chicago STV”, “Chicago STV Channel”, any combination thereof, and the like. It should be appreciated that the application may be named for any region that is at least one of defined by, within, and the like of the border 22 to which the local content 12 pertains.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A method for streaming local community intended content, comprising:
streaming local content through an application on a digital media player; and
displaying the local content on a television communicatively coupled to the digital media player.

2. The method of claim 1, wherein the local content originates within at least one of a county border and a state border of where the digital media player is located.

3. The method of claim 1, wherein the application bears a name of a city where the local community intended content originated.

4. The method of claim 1, wherein the digital media player comprises at least one of a set top box type media player, a stick type media player, a remote computing device, and a computer.

5. The method of claim 4, wherein the remote computing device comprises at least one of a smartphone and tablet device.

6. The method of claim 1, wherein the local community intended content is provided by a local, state, or federal elected official representing the city that bears the name.

7. The method of claim 1, wherein the local community intended content is provided by a community, educational, or faith-based organizational leader; a local business owner; and a political institution.

8. The method of claim 1, wherein the local content is created by a first party having a recurring time slot occurring at a predetermined interval.

9. The method of 8, wherein the predetermined interval comprises at least one of a weekly interval and a daily interval.

10. A method for creating local community intended content, comprising:
recording local content on an application on a remote computing device; and
transmitting the local content to a remote server communicatively coupled to the remote computing device.

11. The method of claim 10, further comprising streaming the local content through an application on a digital media player.

12. The method of claim 10, wherein the remote computing device comprises at least one of a smartphone and tablet device.

13. The method of claim 10, wherein the remote computing device comprises a computer.

14. The method of claim 10, wherein the local content is created by an elected official located within a voting district of where the digital media player is located.

15. The method of claim 10, wherein the local content is created by an educational institution located within a school district of where the digital media player is located.

16. The method of claim 10, wherein the local content is created by a religious institution located within a county border of where digital media player is located.

17. A method for viewing local community intended content, comprising:
downloading an application on a digital media player; and
displaying local content on a television communicatively coupled to the digital media player.

18. The method of claim 17, prior to downloading the application, the method further comprising searching, via the digital media player, a name of a city in which the digital media player is located.

19. The method of claim 17, prior to downloading the application, the method further comprising searching, via the digital media player, a name of a city to which the local content pertains.

20. The method of claim 19, wherein the application comprises a name that includes the name of the city.
